(19) United States
(12) Patent Application Publication
(10) Pub. No.: US 2019/0196277 A1
(43) Pub. Date: Jun. 27, 2019

(54) ARRAY SUBSTRATE AND METHOD FOR MANUFACTURING THE SAME, AND LIQUID CRYSTAL DISPLAY PANEL

(71) Applicants: Shenzhen China Star Optoelectronics Technology Co., Ltd., Shenzhen (CN); Wuhan China Star Optoelectronics Technology Co., Ltd., Wuhan (CN)

(72) Inventors: Yuejun TANG, Shenzhen (CN); Yafeng LI, Shenzhen (CN)

(73) Assignees: Shenzhen China Star Optoelectronics Technology Co., Ltd., Shenzhen (CN); Wuhan China Star Optoelectronics Technology Co., Ltd., Wuhan (CN)

(21) Appl. No.: 14/907,911

(22) PCT Filed: Dec. 21, 2015
(86) PCT No.: PCT/CN2015/097991

§ 371 Date: Feb. 15, 2018

(30) Foreign Application Priority Data
Nov. 5, 2015 (CN) 201510745175.X

(51) Int. Cl. G02F 1/1343; G02F 1/1335

(52) U.S. Cl. CPC G02F 1/134336; G02F 1/133512

(57) ABSTRACT

Disclosed is an array substrate and a method for manufacturing the same, a liquid crystal display panel, wherein the array substrate includes: a first material layer and a first conductive layer formed on the first material layer, wherein a region of the first material layer that is not covered by the first conductive layer is etched away in whole or in part along a thickness direction. The array substrate can enable an effective gap of a liquid crystal cell to be increased, thereby improving the transmittance of the panel, and meanwhile can ensure that the response time of the liquid crystal display panel containing the array substrate will not be increased.

### CROSS-REFERENCE TO RELATED APPLICATIONS

This application claims the priority of Chinese patent application CN201510745175.X, entitled “Array Substrate and Method for Manufacturing the Same, and Liquid Crystal Display Panel” and filed on Nov. 5, 2015, the entirety of which is incorporated herein by reference.

### FIELD OF THE INVENTION

The present disclosure relates to the technical field of liquid crystal imaging, and in particular, to an array substrate and a method for manufacturing the same, and a liquid crystal display panel.

### BACKGROUND OF THE INVENTION

The liquid crystal display device has the advantages of low radiation, small size and low energy consumption, and it has gradually replaced the traditional cathode ray tube display device and has been widely used in products such as a flat-panel television, a personal computer and a mobile display panel, etc.

For a liquid crystal display panel, improving the transmittance of the liquid crystal display panel can greatly improve the utilization of backlight. Since most of the power consumption of the whole liquid crystal display device is the energy consumption of the backlight, improving the utilization of the backlight can help to reduce the energy consumption of the backlight, thereby reducing the power consumption of the whole liquid crystal display device.

Besides the factors such as the transmittance of respective layers of materials and the aperture ratio of pixels, the liquid crystal cell gap can also affect the transmittance of the liquid crystal display panel. FIG. 1 shows a graph of relationship between a transmittance Tr of a liquid crystal display panel and a liquid crystal cell gap. As can be seen from FIG. 1, the increase of the liquid crystal cell gap helps to improve the transmittance Tr.

FIG. 2 shows a graph if relationship between a response time RT of a liquid crystal display panel and a liquid crystal cell gap. As can be seen from FIG. 2, with the increase of the liquid crystal cell gap, the response time RT of the liquid crystal display panel increases. This is because with the increase of the liquid crystal cell gap, the electric field away from the electrode becomes weak, which causes a corresponding increase in the time for the liquid crystal away from the electric field to produce a required deflection angle, and meanwhile the recovery time for the liquid crystal away from the electric field is increased correspondingly.

### SUMMARY OF THE INVENTION

The existing liquid crystal display panel improves the transmittance Tr by increasing the liquid crystal cell gap, but the increase of the liquid crystal cell gap will cause the increase of the response time RT of the liquid crystal display panel, thereby affecting the imaging quality of the panel. To solve the above problem, the present disclosure first provides a new array substrate in one embodiment, the array substrate comprising: a first material layer and a first conductive layer formed on the first material layer, wherein a region of the first material layer that is not covered by the first conductive layer is etched away in whole or in part along a thickness direction.

According to one embodiment of the present disclosure, the array substrate further comprises a second conductive layer, on which the first material layer is formed.

According to on embodiment of the present disclosure, the first material layer comprises a plurality of sub-material layers.

According to one embodiment of the present disclosure, the first material layer is obtained by etching with a photomask matching the first conductive layer; or the first material layer is obtained by etching with the first conductive layer as a photomask.

The present disclosure further provides a liquid crystal display panel comprising an array substrate according to any of the above.

The present disclosure further provides a method for manufacturing an array substrate, the method comprising:
forming a first material layer, and forming a first conductive layer on the first material layer; and
etching the first material layer so as to etch away in whole or in part a region of the first material layer that is not covered by the first conductive layer, along a thickness direction.

According to one embodiment of the present disclosure, the method further comprises: prior to forming the first material layer, forming a second conductive layer, the first material layer being directly or indirectly formed on the second conductive layer.

According to one embodiment of the present disclosure, the method comprises:
etching the first material layer using a photomask having a preset pattern; or
etching the first material layer by using the first conductive layer as a photomask.

The present disclosure further provides a method for manufacturing an array substrate, the method comprising:
forming a first material layer, and etching the first material layer to make the first material layer form a preset pattern; and
forming a first conductive layer on the preset pattern.

According to one embodiment of the present disclosure, the method further comprises: prior to forming the first material layer, forming a second conductive layer, the first material layer being directly or indirectly formed on the second conductive layer.

The array substrate provided by the present disclosure enables the effective gap of the liquid crystal cell to be increased, thereby improving the transmittance Tr of the panel. At the same time, since the region where the effective gap of the liquid crystal cell is increased is below the side of the pixel electrode and near the pixel electrode, and furthermore there is a strong electric field at the bottom and side of the pixel electrode, the liquid crystal molecules in this region can be deflected rapidly under the action of the electric field, which makes the response time RT of the liquid crystal display panel not increased.

In addition, with the principle of improving the transmittance of the liquid crystal display panel as provided by the present disclosure, when producing the liquid crystal display panel, it is also possible to appropriately reduce the distance between the array substrate and the CF substrate in the case of guaranteed transmittance, which helps to reduce the liquid crystal cell gap, thereby reducing the response time RT of the liquid crystal display panel. Meanwhile, reducing the liquid crystal cell gap can also reduce the oblique light leakage of the adjacent sub pixels when viewed from a large-viewing angle, thereby alleviating the large-viewing angle color shift of the liquid crystal display panel.

Other features and advantages of the present disclosure will be illustrated in the following description, and partly become obvious from the description or understood by implementing the present disclosure. The objects and other advantages of the present disclosure can be achieved and obtained by the structures particularly pointed out in the description, the claims and the accompanying drawings.

### BRIEF DESCRIPTION OF THE DRAWINGS

In order to illustrate the embodiments of the present disclosure or the technical solutions in the prior art more clearly, a brief introduction will be made below to the accompanying drawings required in the descriptions of the embodiments or the prior art:

FIG. 1 is a graph of relationship between a transmittance of a liquid crystal display panel and a liquid crystal cell gap;

FIG. 2 is a graph of relationship between a response time of a liquid crystal display panel and a liquid crystal cell gap;

FIG. 3 is a structural schematic diagram of an existing FFS type liquid crystal display panel;

FIG. 4 is a schematic diagram of color mixing occurring to the oblique incidence light at the junction point of adjacent sub pixels in an existing FFS type liquid crystal display panel;

FIG. 5 is a structural schematic diagram of an FFS type liquid crystal display panel according to one embodiment of the present disclosure;

FIG. 6 is a structural schematic diagram of an FFS type liquid crystal display panel according to another embodiment of the present disclosure;

FIG. 7 is a structural schematic diagram of an existing IPS type liquid crystal display panel;

FIG. 8 is a structural schematic diagram of an IPS type liquid crystal display panel according to one embodiment of the present disclosure;

FIG. 9 is a structural schematic diagram of an IPS type liquid crystal display panel according to another embodiment of the present disclosure;

FIG. 10 is a structural schematic diagram of the junction position of adjacent sub pixels in an FFS type liquid crystal display panel according to one embodiment of the present disclosure; and

FIG. 11 is a structural schematic diagram of the junction position of adjacent sub pixels in an FFS type liquid crystal display panel according to another embodiment of the present disclosure.

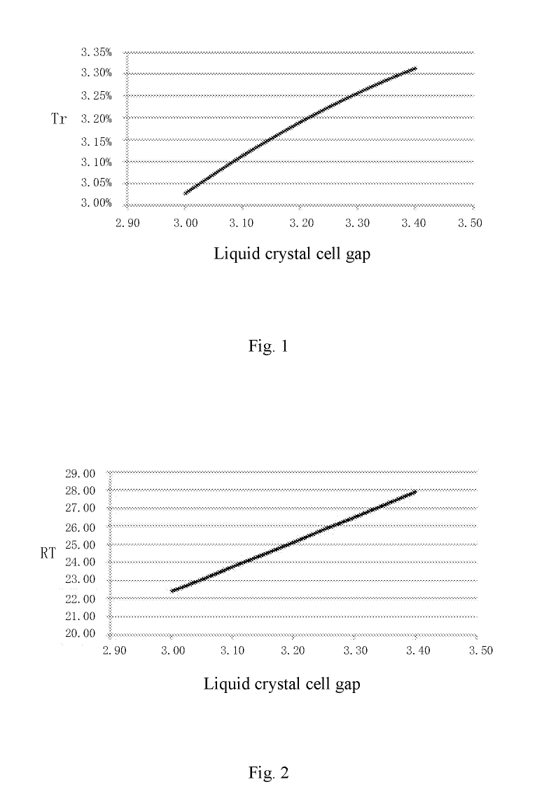

### DETAILED DESCRIPTION OF THE EMBODIMENTS

The implementation mode of the present disclosure will be described in detail below with reference to the accompanying drawings and embodiments, by means of which, the implementation process regarding how the present disclosure uses technical means to solve the technical problem and achieve the technical effect can be fully understood and implemented accordingly. It should be noted that, as long as there is no conflict, respective embodiments in the present disclosure and respective features in the respective embodiments can be combined with each other, and the formed technical solutions are all within the protection scope of the present disclosure.

Meanwhile, in the following descriptions, numerous specific details are set forth for the purpose of explanation to thereby provide a thorough understanding of the embodiments of the present disclosure. However, it would be apparent for those skilled in the art that the present disclosure may be implemented without the specific details or particular modes described here.

The existing liquid crystal display panel improves the transmittance Tr of the panel by increasing the liquid crystal cell gap, but the increase of the liquid crystal cell gap will cause the increase of the response time RT of the liquid crystal display panel.

In order to solve the above problem, the present disclosure provides a new array substrate and a liquid crystal display panel comprising the array substrate. In the array substrate provided by the present disclosure, a first conductive layer as a pixel electrode is formed on a first material layer, wherein a region of the first material layer that is not covered by the first conductive layer is etched away in whole or in part along a thickness direction. Such a structure of the array substrate can increase an effective gap of the liquid crystal cell, thereby effectively improving the transmittance Tr of the liquid crystal display panel, without increasing the response time RT of the liquid crystal display panel.

The array substrate provided by the present disclosure can be applied to different types of liquid crystal display panels, such as an FFS type and an IPS type. The objectives principles and advantages of the present disclosure will be further illustrated below by respectively taking an FFS type liquid crystal display panel and an IPS type liquid crystal display panel as an example.

### Embodiment 1

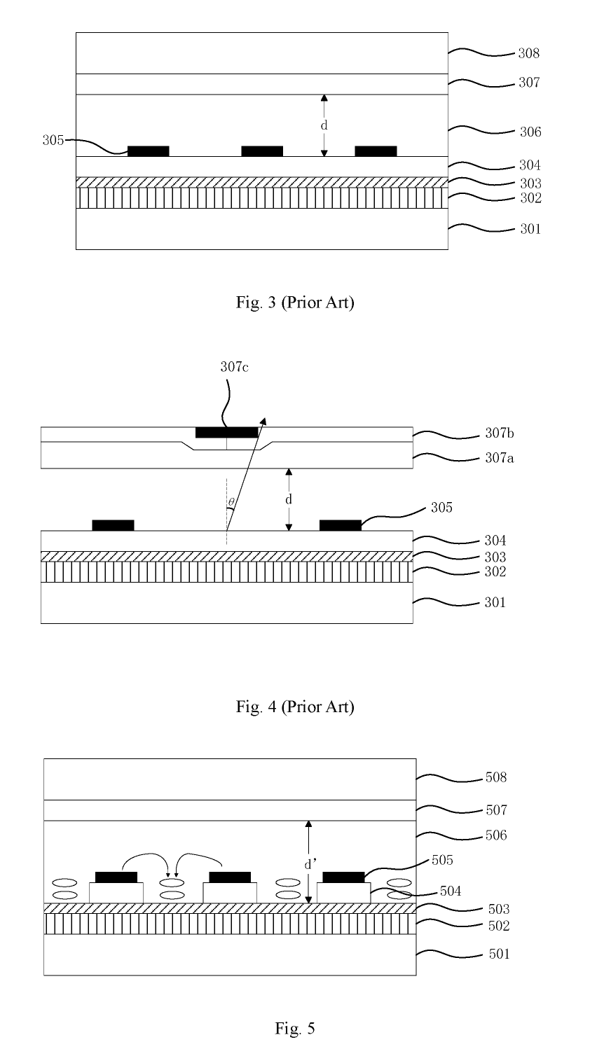

FIG. 3 shows a structural schematic diagram of an existing FFS type liquid crystal display panel.

As shown in FIG. 3, the existing liquid crystal display panel comprises: an array substrate, a liquid crystal cell 306 and a CF substrate. The array substrate comprises: a lower substrate 301, a first insulating layer 302, a common electrode 303, a second insulating layer 304 and a pixel electrode 305. The CF substrate comprises a color filter 307 and a glass substrate 308. The pixel electrode 305 is formed on the second insulating layer 304. For the liquid crystal cell 306, its gap is a distance d between the color filter 307 and the second insulating layer 304. For the existing FFS type liquid crystal display panel, the gap d of the liquid crystal cell is just the effective gap thereof. The lower substrate 301 comprises structures such as a transparent lining board, an insulating isolation layer, and scan lines and/or data lines in a non-opening area, wherein the transparent lining board can be made of materials such as glass or resin.

FIG. 4 schematically shows a schematic diagram of color mixing occurring to the oblique incidence light at the junction point of adjacent sub pixels in the FFS type liquid crystal display panel as shown by FIG. 3, and meanwhile FIG. 4 schematically shows the junction area/edge area of sub pixels.

As shown in FIG. 4, the color filter 307 comprises: a flat layer 307a, a color barrier layer 307b, and a black matrix 307c. When a sub pixel is turned on and its adjacent sub pixel is turned off, the voltage of the sub pixel that is turned on will affect the rotation of the liquid crystal between the two adjacent sub pixels to a certain extent. In order to simplify the model, without considering the partial blocking effect of the data line on the light between adjacent sub pixels, the critical angle θ of the oblique incidence light where color mixing occurs at the junction point of two adjacent sub pixels can be approximately calculated according to the following expression:

$$tan θ = \frac{{L}_{EM}}{2 ( {T}_{PR} + {T}_{OC} + d )} \qquad ( 1 )$$

where, L_{BM} denotes the width of the black matrix; T_{PR} denotes the thickness of the color barrier layer; T_{OC} denotes the thickness of the flat layer; and d denotes the gap of the liquid crystal cell.

The existing liquid crystal display panel improves the transmittance Tr of the panel by increasing the gap of the liquid crystal cell 306, but the increase of the liquid crystal cell gap will also cause the increase of the response time RT of the liquid crystal display panel. Meanwhile, it can be seen from the expression (1) that, without changing the other structures of the liquid crystal display panel, increasing the liquid crystal cell gap will also make the color mixing critical angle θ reduced, while the reduction of the color mixing critical angle θ will aggravate the strabismus light leakage of the liquid crystal display panel.

In order to solve the above problem, the present embodiment provides a new FFS type liquid crystal display panel. FIG. 5 shows a structural schematic diagram of the liquid crystal display panel, wherein FIG. 5 also schematically shows a pixel transmission area/a pixel central area.

As shown in FIG. 5, similar to the liquid crystal display panel shown in FIG. 3, the liquid crystal display panel provided in the present embodiment comprises: an array substrate, a liquid crystal cell 506 and a CF substrate. The array substrate comprises: a lower substrate 501, a second material layer 502, a second conductive layer 503, a first material layer 504 and a first conductive layer 505. The first material layer 504 is formed between the first conductive layer 505 and the second conductive layer 503 so that the first conductive layer 505 and the second conductive layer 503 can keep insulation isolation therebetween.

In the FFS type liquid crystal display panel provided in the present embodiment, the first conductive layer 505 forms a pixel electrode, and the second conductive layer 503 forms a common electrode, and the two conductive layers are both realized by an ITO thin film. It should be noted that in other embodiments of the present disclosure, the first conductive layer and/or the second conductive layer may also be realized using other reasonable materials, and the present disclosure is not limited thereto.

In order to improve the transmittance of the liquid crystal display panel, as shown in FIG. 5, in the liquid crystal display panel provided in the present embodiment, the region of the first material layer 504 that is not covered by the first conductive layer 505 is etched away in whole along a thickness direction. Thus, the effective gap d′ of the liquid crystal cell can be calculated according to the following expression:

d′=d+T₁ (2)

where, T₁ denotes the thickness of the first material layer 504.

In the present embodiment, the first material layer 504 is a SiN, layer. Of course, in other embodiments of the present disclosure, the first material layer 504 may also be realized by other reasonable materials, and the present disclosure is not limited thereto. Meanwhile, in different embodiments of the present disclosure, the first material layer 504 and/or the second material layer 502 can be either a single layer structure or a multilayer structure composed of a same material or different materials (i.e., the first material layer and/or the second material layer comprise a plurality of sub-material layers), and the present disclosure is also not limited thereto.

The present embodiment further provides a method for manufacturing the above-described array substrate.

In the array substrate manufacturing method provided by the present embodiment, after the second conductive layer 503 (i.e., the common electrode) is formed on the second material layer 502, the first material layer 504 is formed on the second conductive layer 503. The first material layer 504 is then etched such that the first material layer 504 forms a preset pattern. The preset pattern is a pattern that matches (e.g., the same) with the first conductive layer 505 (i.e., the pixel electrode). After the etching of the first material layer 504 is completed, a first conductive layer is formed on the obtained preset pattern to thereby obtain a desired array substrate.

In the present embodiment, the first material layer 504 is etched preferably by photolithography. When etching the first material layer 504, a photomask having a preset pattern is employed for the etching. Of course, in other embodiments of the present disclosure, other reasonable means (e.g., wet etching, etc.) may also be employed to etch the first material layer 504, and the present disclosure is not limited thereto.

In addition, in other embodiments of the present disclosure, when manufacturing the above-described array substrate, it is also possible to form the first conductive layer 506 on the first material layer 504 after forming the first material layer 504, and then to etch the first material layer 504 with the photomask having a preset pattern so that the region of the first material layer 504 that is not covered by the first conductive layer 506 is etched away in whole along the thickness direction, thereby obtaining the desired array substrate.

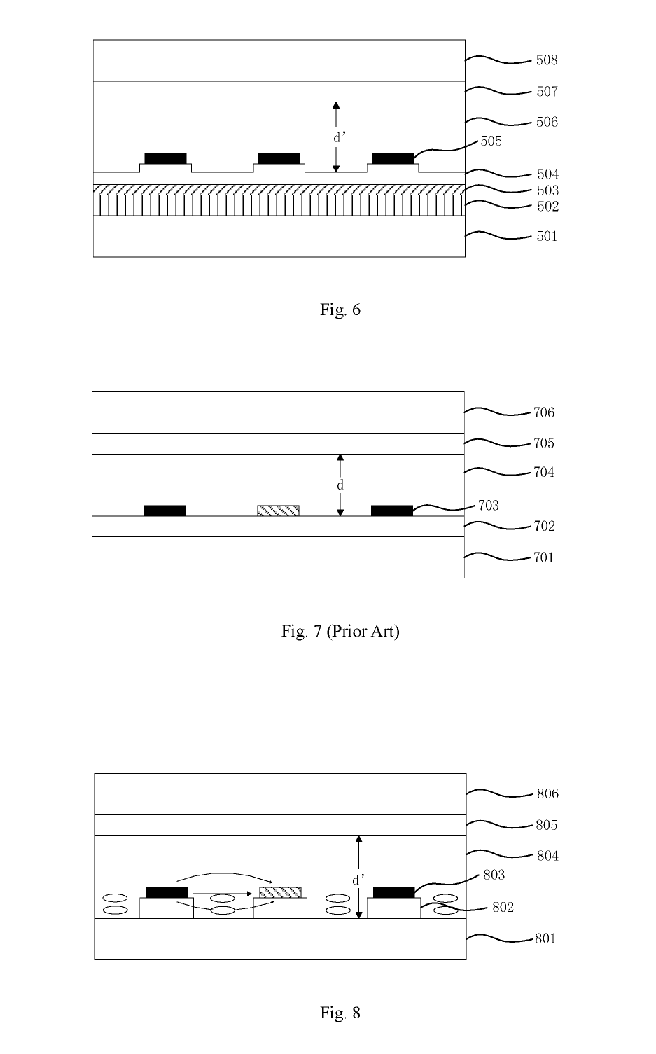

It should be noted that in other embodiments of the present disclosure, it is also possible to etch the first material layer 504 using the structure of the first material layer itself as a photomask, and the present disclosure is not limited thereto. Meanwhile, as shown in FIG. 6, in other embodiments of the present disclosure, it is also possible to etch away only a part of the first material layer 504 that is not covered by the first conductive layer 506, along the thickness direction, which also can increase the effective gap of the liquid crystal cell.

### Embodiment 2

FIG. 7 shows a structural schematic diagram of an existing IPS type liquid crystal display panel.

As shown in FIG. 7, the existing liquid crystal display panel comprises: an array substrate, a liquid crystal cell 704 and a CF substrate. The array substrate comprises: a lower substrate 701, an insulating layer 702 and an electrode layer 703. The CF substrate comprises a color filter 705 and a glass substrate 706. The electrode layer 703 (comprising the pixel electrode and the common electrode) is formed on the insulating layer 702. For the liquid crystal cell 704, its gap is a distance d between the color fitter 705 and the insulating layer 702. For the existing IPS type liquid crystal display panel, the gap d of the liquid crystal cell is just the effective gap thereof.

The existing liquid crystal display panel improves the transmittance Tr of the panel by increasing the gap of the liquid crystal cell 704, but the increase of the liquid crystal cell gap will also cause the increase of the response time RT of the liquid crystal display panel. Meanwhile, it can be seen from the expression (1) in Embodiment 1 that, without changing the other structures of the liquid crystal display panel, increasing the liquid crystal cell gap will also make the color mixing critical angle θ reduced, while the reduction of the color mixing critical angle θ will aggravate the strabismus light leakage of the liquid crystal display panel.

In order to solve the above problem, the present embodiment provides a new IPS type liquid crystal display panel, and FIG. 8 shows a structural schematic diagram of the liquid crystal display panel.

As shown in FIG. 8, the liquid crystal display panel provided in the present embodiment comprises: an array substrate, a liquid crystal cell 804 and a CF substrate. The array substrate comprises: a lower substrate 801, a first material layer 802 and a first conductive layer 803. The first material layer 802 is formed between the first conductive layer 803 and the lower substrate 801.

In the IPS type liquid crystal display panel provided in the present embodiment, the first conductive layer 803 constitutes a pixel electrode layer and a common electrode, which are realized by an ITO thin film. It should be noted that in other embodiments of the present disclosure, the first conductive layer may also be realized using other reasonable materials, and the present invention is not limited thereto.

In order to improve the transmittance of the liquid crystal display panel, as shown in FIG. 8, in the liquid crystal display panel provided in the present embodiment, the region of the first material layer 802 that is not covered by the first conductive layer 803 is etched away in whole along a thickness direction. In this way, the effective gap d′ of the liquid crystal cell becomes d+T₁, where T₁ denotes the thickness of the first material layer 802.

In the present embodiment, the first material layer 802 is a SiN, layer. Of course, in other embodiments of the present disclosure, the first material layer 802 may also be realized by other reasonable materials, and the present disclosure is not limited thereto. Meanwhile, in different embodiments of the present disclosure, the first material layer 802 can be either a single layer structure or a multilayer structure composed of a same material or different materials (i.e., the first material layer comprises a plurality of sub-material layers), and the present disclosure is also not limited therein.

In addition, it needs to be pointed out that in other embodiments of the present disclosure, in order to further increase the effective gap of the liquid crystal cell 804, when a flat layer is present under the pixel electrode or the common electrode of the IPS liquid crystal display panel, the etched first material layer may also comprise a portion of the flat layer, and the present disclosure is also not limited thereto.

The present embodiment further provides a method for manufacturing the above-described array substrate.

In the array substrate manufacturing method provided by the present embodiment, after the first material layer 802 is formed on the lower substrate 801, the first material layer 802 is etched so that the first material layer 802 forms a preset pattern. The preset pattern is preferably the same pattern as the first conductive layer 803. After the etching of the first material layer 802 is completed, the first conductive layer 803 is formed on the obtained preset pattern to thereby obtain a desired array substrate.

In the present embodiment, the first material layer 802 is etched preferably by photolithography. When etching the first material layer 802, a photomask having a preset pattern is employed for the etching. Of course, in other embodiments of the present disclosure, other reasonable means (e.g., wet etching, etc.) may also be employed to etch the first material layer 802, and the present disclosure is not limited thereto.

Of course, in other embodiments of the present disclosure, when manufacturing the above-described array substrate, it is also possible to form the first conductive layer 803 on the first material layer 802 after forming the first material layer 802, and then to etch the first material layer 802 with the photomask having a preset pattern so that the region of the first material layer 802 that is not covered by the first conductive layer 803 is etched away in whole along the thickness direction, thereby obtaining the desired array substrate.

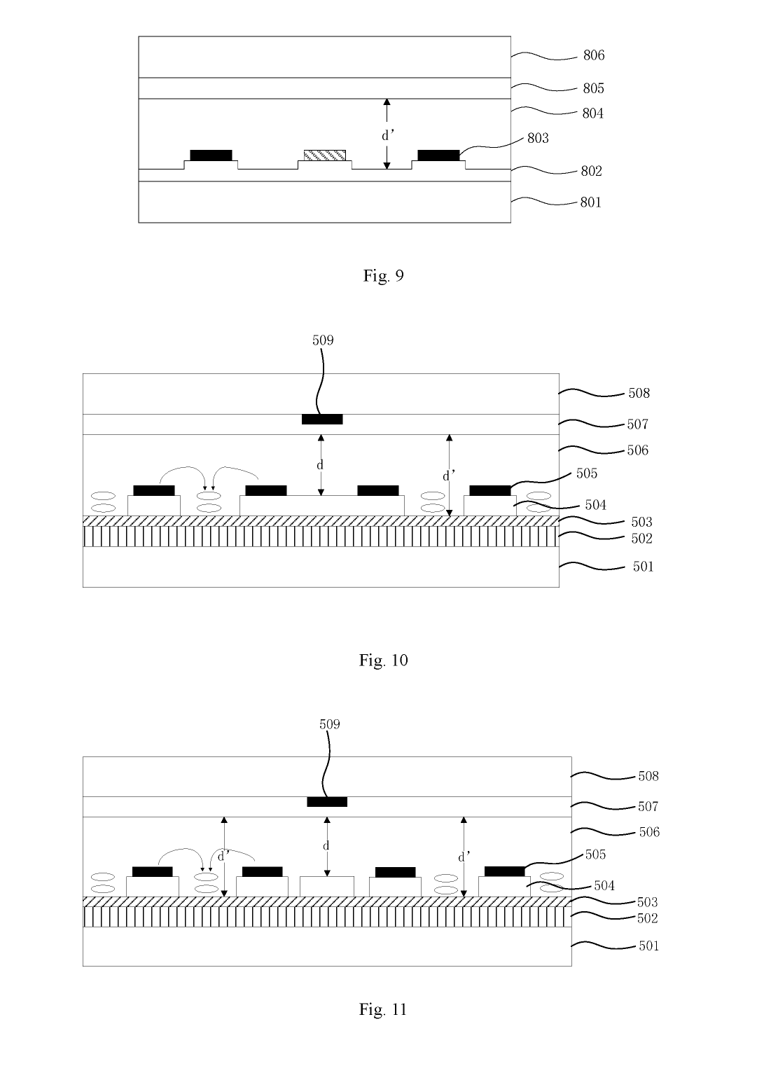

It should be noted that in other embodiments of the present disclosure, it is also possible to etch the first material layer 802 using the structure of the first conductive layer 803 itself as a photomask, and the present disclosure is not limited thereto. Meanwhile, as shown in FIG. 9, in other embodiments of the present disclosure, it is also possible to etch away only a part of the first material layer 802 that is not covered by the first conductive layer 803, along the thickness direction, which also can increase the effective gap of the liquid crystal cell.

It can be seen from the above descriptions that the array substrate provided by the present disclosure enables the effective gap of the liquid crystal cell to be increased, thereby improving the transmittance Tr of the panel. At the same time, since the region where the effective gap of the liquid crystal cell is increased is below the side of the pixel electrode and near the pixel electrode, and furthermore there is a strong electric field at the bottom and side of the pixel electrode, the liquid crystal molecules in this region can be deflected rapidly under the action of the electric field, which makes the response time RT of the liquid crystal display panel not increased.

In addition, with the principle of improving the transmittance Tr of the liquid crystal display panel as provided by the present disclosure, when producing the liquid crystal display panel, it is also possible to appropriately reduce the distance between the array substrate and the CF substrate in the case of guaranteed transmittance Tr, which helps to reduce the liquid crystal cell gap, thereby reducing the response time RT of the liquid crystal display panel. Meanwhile, it can be learned from the expression (1) that reducing the liquid crystal cell gap can also increase the color mixing critical angle θ of adjacent sub pixels, thereby reducing the oblique light leakage of the adjacent sub pixels, and further alleviating the large-viewing angle color shift of the liquid crystal display panel.

Specifically, according to the structural schematic diagram of the junction position of adjacent sub pixels in an array substrate as shown in FIG. 10, it can be learned that the first material layer 504 in the position corresponding to the black matrix of the array substrate provided by the present disclosure is not etched, and here the effective gap of the liquid crystal cell is still the distance d of the color filter 507 to the first material layer 504. Since the effective gap (i.e., the distance of the color filter 507 to the second conductive layer 503) d′ of the liquid crystal cell at each pixel opening region of the array substrate provided by the present disclosure is larger than the effective gap (i.e. the distance of the color filter 507 to the first material layer 504) d of the liquid crystal cell at the position corresponding to the black matrix 509, the transmittance Tr of the entire panel is improved and the response time RT is reduced. Since the effective gap of the liquid crystal cell in the pixel opening region is increased, it is possible to increase the color mixing critical angle θ by appropriately reducing the effective gap d of the liquid crystal cell at the position of the black matrix 509 in the case of satisfying the design requirements of the transmittance Tr and response time RT, thus reducing the light leakage between adjacent sub pixels and alleviating the large-viewing angle color shift of the liquid crystal display panel.

It needs to be pointed out that in other embodiments of the present disclosure, as shown in FIG. 11, the first material layer 504 in the position corresponding to the black matrix 509 between adjacent sub pixels may also be partially etched, which will also help to increase the electric field distribution at the junction position of adjacent sub pixels, and the present disclosure is not limited thereto.

It should be understood that the embodiments disclosed herein are not limited to the specific structures, processing steps or materials disclosed herein, but should be extended to the equivalent substitutions of these features as understood by those of ordinary skill in the relevant art. It should also be understood that the terms used herein are only for the purpose of describing particular embodiments, and do not mean limitation.

“One embodiment” or “embodiments” as mentioned in the description means that a particular feature, structure, or characteristic described in conjunction with the embodiments is comprised in at least one embodiment of the present disclosure. Thus, the phrase “one embodiment” or “embodiments” appearing throughout the description does not necessarily refer to the same embodiment.

Although the foregoing examples are used to illustrate the principles of the present disclosure in one or more applications, it will be apparent to those skilled in the art that, without departing from the principles and ideas of the present disclosure, various modifications can be made in the form, usage, and implementation details without having to pay creative work. Accordingly, the present disclosure is defined by the appended claims.

1. An array substrate, wherein the array substrate comprises: a first material layer and a first conductive layer formed on the first material layer, wherein a region of the first material layer that is not covered by the first conductive layer is etched away in whole or in part along a thickness direction.

2. The array substrate according to claim 1, wherein the array substrate further comprises a second conductive layer, on which the first material layer is formed.

3. The array substrate according to claim 1, wherein the first material layer comprises a plurality of sub-material layers.

4. The array substrate according to claim 2, wherein the first material layer comprises a plurality of sub-material layers.

5. The array substrate according to claim 1, wherein
the first material layer is obtained by etching with a photomask matching the first conductive layer; or
the first material layer is obtained by etching with the first conductive layer as a photomask.

6. A liquid crystal display panel, wherein the liquid crystal display panel is provided with an array substrate, the array substrate comprising:
a first material layer and a first conductive layer formed on the first material layer, wherein a region of the first material layer that is not covered by the first conductive layer is etched away in whole or in part along a thickness direction.

7. The liquid crystal display panel according to claim 6, wherein the array substrate further comprises a second conductive layer, on which the first material layer is formed.

8. The liquid crystal display panel according to claim 6, wherein the first material layer comprises a plurality of sub-material layers.

9. The liquid crystal display panel according to claim 7, wherein the first material layer comprises a plurality of sub-material layers.

10. The liquid crystal display panel according to claim 6, wherein
the first material layer is obtained by etching with a photomask matching the first conductive layer; or
the first material layer is obtained by etching with the first conductive layer as a photomask.

11. A method for manufacturing an array substrate, wherein the method comprises:
forming a first material layer, and forming a first conductive layer on the first material layer; and
etching the first material layer so as to etch away in whole or in part a region of the first material layer that is not covered by the first conductive layer, along a thickness direction.

12. The method according to claim 11, wherein the method further comprises: prior to forming the first material layer, forming a second conductive layer, wherein the first material layer is directly or indirectly formed on the second conductive layer.

13. The method according to claim 11, wherein the method comprises:
etching the first material layer using a photomask having a preset pattern; or
etching the first material layer by using the first conductive layer as a photomask.

14. The method according to claim 12, wherein the method comprises:
etching the first material layer using a photomask having a preset pattern; or
etching the first material layer by using the first conductive layer as a photomask.
